(19) United States
(12) Patent Application Publication
(10) Pub. No.: US 2016/0230949 A1
(43) Pub. Date: Aug. 11, 2016

(54) VEHICLE LIGHTING DEVICE

(71) Applicant: Valeo Vision, Bobigny Cedex (FR)

(72) Inventors: Antoine de Lamberterie, Paris (FR); Pierre Albou, Paris (FR)

(21) Appl. No.: 15/014,262

(22) Filed: Feb. 3, 2016

(30) Foreign Application Priority Data
Feb. 5, 2015 (FR) 1550892

(51) Int. Cl. F21S 8/10

(52) U.S. Cl. CPC F21S 48/1394; F21S 48/1317; F21S 48/1376; F21S 48/1241; F21S 48/1159

(57) ABSTRACT

A vehicle lighting device including a transparent material lighting optical component, delimited by

at least one entry surface,

at least one first reflection surface arranged substantially facing the at least one entry surface, and

an exit surface,

wherein the first reflection surface is oriented relative to the at least one entry surface so that light rays from a light source passing through the at least one entry surface are directed by the first reflection surface toward the exit surface, wherein the transparent material lighting optical component includes a light source arranged relative to the at least one entry surface of the transparent material lighting optical component so that light rays from the light source passing through the at least one entry surface are reflected by the first reflection surface toward the exit surface.

### CROSS-REFERENCE TO RELATED APPLICATIONS

This application claims priority to the French application 1550892 filed Feb. 5, 2015, which application is incorporated herein by reference and made a part hereof.

### BACKGROUND OF THE INVENTION

1. Field of the Invention

The invention concerns a vehicle lighting device using an optical component and a light source.

2. Description of the Related Art

A motor vehicle front headlight includes a light source intended to illuminate a road in front of the vehicle under low-light conditions in order to enable the driver to drive their vehicle safely or to render the vehicle visible under daylight conditions. For example, there may notably be cited the low beam (LB), parking lights (PL) and daytime running lamp (DRL) functions. Such a headlight, notably its low beam, make it possible to produce a light beam making it possible to illuminate the road and the light distribution of which, as observed in a vertical plane a few meters from the vehicle, features a cut-off separating a zone illuminated by the beam and a non-illuminated zone, in order not to dazzle the drivers of vehicles being followed or approaching in the opposite direction. The horizontal cut-off, which is prescribed by law, includes a portion that is horizontal and a portion that is inclined, for example at 15° relative to the horizontal.

The vehicle headlights as described typically include one or more light sources and a reflector. To provide the low beam function, the light source or sources and the reflector are arranged so that the light rays from each light source are directed toward the front of the vehicle and downward below the cut-off. The reflector typically has a curved surface covered with a deposit of aluminum to reflect light. The light source faces the curved surface of the reflector.

For aesthetic reasons, notably the exterior styling of the headlight, the reflector may be replaced with an optical lens to collimate the light rays from the light source. The lens consists of a transparent material component placed in front of the light source. This light source may be a semiconductor light source, for example, such as a light-emitting diode (LED).

This lens is usually employed to redirect light rays emitted by the light source. The position of the light source relative to the lens is at least in part dictated by thermal constraints. In fact, the temperature of the light source can cause deterioration of the lens.

### SUMMARY OF THE INVENTION

The objective of the invention is to propose a transparent material component and a corresponding lighting device for vehicles that take account of these thermal constraints and the efficiency of which is improved at the same time as offering a smaller overall size.

To address this objective, the invention has firstly for subject matter a transparent material lighting optical component, delimited by:
at least one entry surface;
at least one first reflection surface arranged substantially facing the principal entry surface; and
an exit surface;
wherein the first reflection surface is oriented relative to the principal entry surface so that light rays from a light source passing through the principal entry surface are directed by the first reflection surface toward the exit surface.

In a preferred embodiment, wherein the transparent material lighting optical component includes at least one edge that extends from the entry surface toward the exterior of the transparent material lighting optical component.

The transparent material lighting optical component in accordance with the invention has a compact geometry and its manufacture is therefore facilitated and economical. The optical component serves both as a reflector and as an optical lens. It may be regarded as a light guide with a reflecting surface.

The transparent material lighting optical component in accordance with the invention is therefore intended to be used in a vehicle lighting device, in combination with at least one light source placed at the level of the entry surface, so as to obtain a resulting light beam issuing from the exit surface that can be used to form a statutory beam for a motor vehicle, notably a cut-off beam.

If the edge, edge surface or supplemental entry surface is used, the thermal problems are circumvented by moving the light source away from the entry surface by a distance sufficient for there to be no deterioration of the transparent material lighting optical component, whilst recovering a significant proportion of the light rays that do not enter the entry surface by means of the edge, otherwise referred to as the edge surface, formed on the transparent material lighting optical component.

It will be noted that the first reflection surface collimates the light rays entering the solid transparent material lighting optical component via the entry surface in the direction toward the exit surface.

In accordance with one aspect of the invention, the edge constitutes a supplementary entry surface for light rays so that light rays from the light source that do not reach the principal entry surface and pass through the supplementary entry surface are directed toward the exit surface.

The edge delimits a portion of the entry surface projecting toward the exterior of the optical component. The projecting portion therefore forms a step, otherwise referred to as a shoulder, that originates on a plane of the entry surface and extends toward the environment around the optical component. It is in this sense that the projecting portion projects toward the outside.

The projecting portion extends the exit surface above the entry surface.

The projecting, or raised, portion is made of a transparent material and has a surface parallel to the entry surface.

The projecting portion covers only part of the entry surface and is delimited by the edge extending vertically and constituting the supplementary entry surface so that light rays from the light source passing through the supplementary entry surface are directed toward the exit surface. Some of the light rays or beams from the source with high emission angles that do not reach the entry surface are therefore recovered by the supplementary entry surface. The light gain is between 15% and 20% compared to a prior art device. The proportion of rays recovered by the invention can reach 50% of the light emitted at a high angle and not illuminating the entry surface. There is therefore obtained a transparent material lighting optical component having a high efficiency.

The transparent material lighting optical component with its optional edge and/or its projecting portion forms an integral assembly, otherwise referred to as a monobloc assembly. The transparent material lighting optical component and/or the projecting portion are therefore produced by the same molding operation from the same constituent material.

Alternatively, the transparent material lighting optical component may be formed of at least two components manufactured separately, in this instance the edge and/or the projecting portion and a body of the transparent material lighting optical component delimited at least by the entry surface, the reflection surface and the exit surface. In such a case, the transparent material lighting optical component in accordance with the invention will be obtained when the edge and/or the projecting portion and a body of the transparent material lighting optical component are joined together, for example glued together. It is important that there is no layer of air between the projecting portion and the entry surface once the transparent material lighting optical component has been made.

In accordance with one embodiment, the entry surface is plane and the first reflection surface has a concave shape as seen from the light source. The concave reflection surface therefore makes it possible to reflect a great many light rays with different emission angles from at least one light source by total internal reflection at the transparent material—air interface.

In an independent or complementary manner, the exit surface is plane. Alternatively, this exit surface could include striations that extend in a direction perpendicular to the plane in which the entry surface is inscribed. There may also be provided alone or in combination striations parallel to the plane of the entry surface. The transparent material lighting optical component then has a compact shape. If at least one external light source is placed in the vicinity of the entry surface, the transparent material lighting optical component—light source assembly obtained then extends a short distance in the direction of the resulting light beam issuing from the exit surface.

In accordance with one aspect of the invention, the entry surface and the exit surface are continuous. It is understood here that these two surfaces are joined directly and that only one line of intersection is formed between the entry surface and the exit surface. Alternatively, one or more intermediate surfaces could be provided that connect the entry surface to the exit surface.

The entry surface and the exit surface are each inscribed in a plane perpendicular, or substantially perpendicular (85° to 95°), relative to one another. There is also provision for these planes to form a more marked angle.

The supplementary entry surface is advantageously convex as seen from the light source. Alternatively, the supplementary entry surface may be plane and parallel to the exit surface.

For example, the supplementary entry surface is a cylinder portion the generatrices of which are parallel to the exit surface.

The transparent material lighting optical component in accordance with the invention may beneficially include a second reflection surface extending the first reflection surface, the second reflection surface being coated with a reflective layer so that some of the light rays from the light source passing through the entry surface are reflected toward the exit surface.

In accordance with one aspect of the invention, the exit surface includes integral elements, for example prisms or curved longitudinal surfaces.

In a complementary manner, the second reflection surface includes curved longitudinal surfaces.

The first reflection surface and/or the second reflection surface advantageously include(s) curved longitudinal surfaces each having a convex section.

Curved longitudinal surfaces also create striations on the exit surface. These striations have the advantage that they can easily be molded thanks to the absence of edges or lines of intersection.

The transparent material of the component is, for example, chosen from PMMA (polymethyl methacrylate), PMMI (polymethyl methacrylimide) and polycarbonate. These materials are light in weight, resistant to environmental conditions and offer very good optical properties. In particular, PMMA and PMMI are transparent in the ultraviolet portion of the spectrum.

The invention has secondly for subject matter a vehicle lighting device including a transparent material lighting optical component having any one of the above features, separately or in combination, and a light source arranged relative to the entry surface of the transparent material lighting optical component so that light rays from the light source passing through the entry surface are reflected by the first reflection surface toward the exit surface. The device has a small overall size thanks to the mutual arrangement of the surfaces of the transparent material lighting optical component and the arrangement of the light source relative to the transparent material lighting optical component. Also, the light source can be reached easily if necessary for replacement or repair. A distance left between the entry surface and the light source makes possible tolerances in respect of the positioning of the light source. Moreover, the transparent material of the component is not in direct contact with the light source and the heat produced by the latter can be evacuated in an optimum manner. The fact that the light source is placed above the transparent material lighting optical component, i.e. with an illuminating surface perpendicular, or substantially perpendicular, to the exit surface of the exit component offers wide latitude for installing the lighting device, otherwise referred to as the optical module, within the headlight. The space in the direction of the light beam (direction of the vehicle) being limited, it is advantageous to be able to place the light source above the transparent material lighting optical component.

The light source is preferably placed above and in line with the entry surface. The transparent material lighting optical component and the light source then make possible a very compact arrangement of small overall size. Moreover, this assembly has the advantage of offering a very agreeable visual effect when looking at the headlight from the front, compared to arrangements in which the light source is placed behind the transparent component.

In accordance with one aspect of this second subject matter, a plane passing through an illuminating surface of the light source coincides with a plane passing through an external line of intersection of the edge. Here the external line of intersection of the edge is that between the supplementary entry surface and the upper face of the projecting portion.

The plane passing through an illuminating surface of the light source is inclined relative to a plane in which the entry surface is inscribed. According to one possibility, the plane passing through an illuminating surface of the light source intersects a terminal line of intersection of the transparent material lighting optical component and an external line of intersection of the edge.

The vehicle lighting device can, for example, be incorporated into a vehicle front headlight to obtain a low beam or high beam function. For example, the device may include a single light source to provide the low beam function and two light sources to provide the high beam function.

The external light source preferably includes a light-emitting diode. Such a diode offers good light beam quality and a compactness that is particularly suitable for the transparent material lighting optical component in accordance with the invention. A vehicle lighting device in accordance with the invention advantageously includes a heat sink for cooling the external light source.

In the present application, the terms above, below, top, bottom, horizontal and vertical refer to the position in which the transparent material lighting optical component or the device in accordance with the invention are intended to function within a motor vehicle headlight when the latter is attached to the vehicle.

These and other objects and advantages of the invention will be apparent from the following description, the accompanying drawings and the appended claims.

### BRIEF DESCRIPTION OF THE ACCOMPANYING DRAWINGS

A detailed description of preferred embodiments of a transparent material lighting optical component in accordance with the invention and a vehicle lighting device using such a transparent material lighting optical component is given hereinafter with reference to FIGS. 1 to 9, in which:

FIG. 1 is a perspective view of a transparent material lighting optical component in accordance with the invention;

FIG. 2 is a longitudinal section of the transparent material lighting component from FIG. 1;

FIG. 3 is a longitudinal section of the transparent material lighting optical component showing a few examples of trajectories of light rays from a light source;

FIG. 4 is a partial top view of the transparent material lighting optical component in accordance with one embodiment of the invention;

FIG. 5 is a partial top view of the transparent material lighting optical component in accordance with another embodiment of the invention;

FIG. 6 is a cross section of the transparent material lighting optical component from FIG. 5;

FIG. 7 is a longitudinal section of the transparent material lighting optical component showing one particular position of the light source; and

FIGS. 8 and 9 are longitudinal sections showing the edge in accordance with two embodiments of the invention.

### DETAILED DESCRIPTION OF THE PREFERRED EMBODIMENTS

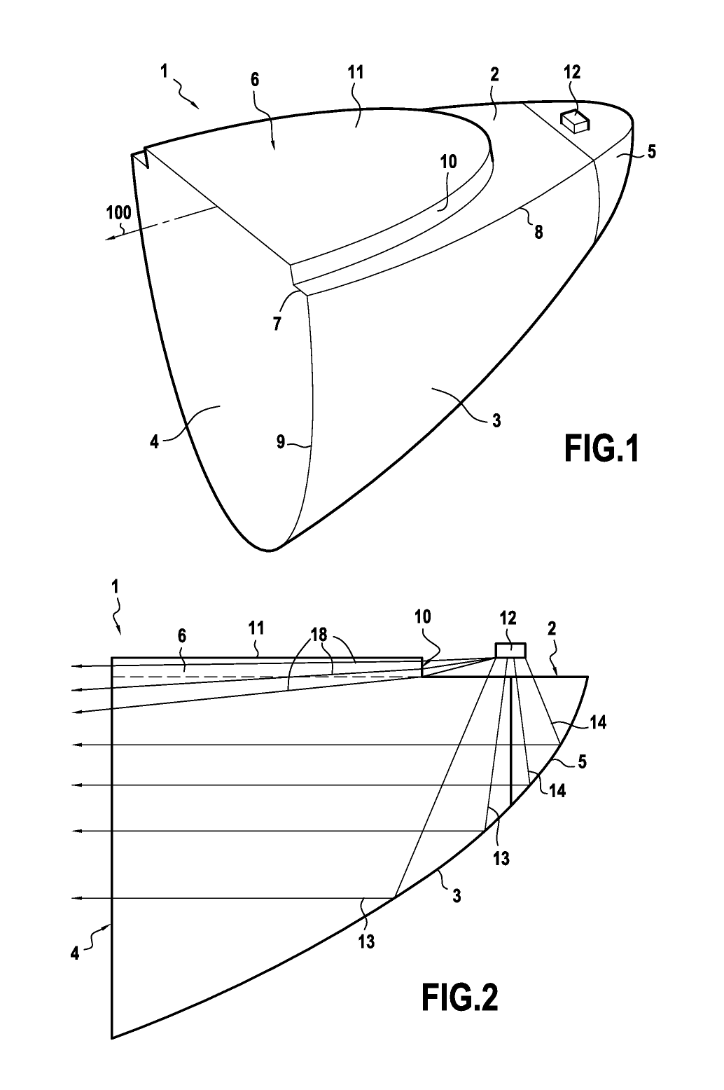

FIG. 1 shows a transparent material lighting optical component 1 in accordance with one embodiment of the invention. The transparent material lighting optical component 1 is notably adapted to be used in a front headlight of a motor vehicle, notably to provide the low beam function.

The transparent material lighting optical component 1 in accordance with the invention is massive, i.e. solid, and is made of PMMA, PMMI or polycarbonate, for example. The transparent material lighting optical component 1 serves both as a reflector and as a light guide. It can be easily manufactured by a molding process. It is shown in FIG. 1 in the orientation in which it can be incorporated into a motor vehicle front headlight. The transparent material lighting optical component 1 has an entry surface 2, a first reflection surface 3 and an exit surface 4. These surfaces, constituted by transparent material—air interfaces, are diopters for refracting and/or reflecting light.

The entry surface 2 is plane and oriented horizontally. The exit surface 4 is also plane, and perpendicular to the entry surface 2. The exit surface 4 is oriented vertically and substantially perpendicularly to the direction of movement of the vehicle. The entry surface 2 and the exit surface 4 are continuous and share a line of intersection 7. The first reflection surface 3 has a curved shape, and is concave with respect to the light rays from a light source 12. The first reflection surface 3 is arranged substantially facing the entry surface 2. The shape of the first reflection surface 3 is close to a shape approximately corresponding to a paraboloid portion. The first reflection surface 3 is delimited by the entry surface 2 and by the exit surface 4. The entry surface 2 and exit surface 4 each have a line of intersection 8, 9 with the first reflection surface 3. The lines of intersection 8, 9 of the first reflection surface 3 are therefore curved.

A direction referenced 100 shows the direction and the sense of emission of the beam formed by the combination of light rays that exit the transparent material lighting optical component 1 via the exit surface 4.

A vehicle lighting device in accordance with the invention includes the transparent material lighting optical component 1 and at least one light source 12 external to the transparent material lighting optical component 1. This light source 12 may be an LED, for example. In the embodiment shown, it is advantageously placed above and in line with the entry surface 2 at a distance from the latter. The light source 12 therefore illuminates the entry surface 2. Light rays from the light source 12 passing through the entry surface 2 are reflected by total internal reflection by the first reflection surface 3 that consists of the transparent material—air interface. The angles of incidence of the light rays on the first reflection surface 3 are such that the rays are reflected by total internal reflection. No reflective treatment of the first reflection surface 3 is necessary. The totally internally reflected light rays are rendered parallel to one another by the shape of the first reflection surface 3. The light rays then propagate toward the exit surface 4 so as to pass through the exit surface 4 substantially perpendicularly to a plane in which the exit surface 4 is inscribed.

As shown in FIGS. 1 and 2, the entry surface 2 advantageously has a portion 6 that projects from the entry surface 2, extending toward the exterior of the transparent material lighting optical component 1 and extending the exit surface 4, notably in the same plane. The projecting portion 6 therefore arises from the entry surface 2 and is joined to the exit surface 4. It includes a surface 11, parallel to the entry surface 2, for example, that partially covers it. The projecting portion 6 is preferably delimited by an edge 10. The edge 10 constitutes a supplementary entry surface that notably extends vertically above the entry surface 2. The light rays from the light source 12 that directly illuminate the supplementary entry surface or edge 10 are directed toward the exit surface 4 by the projecting portion 6.

In the embodiment shown, the supplementary entry surface or edge 10 is curved in a convex manner relative to incident light rays from the light source 12. Alternatively, the supplementary entry surface or edge 10 may be plane and/or parallel to the exit surface 4.

Referring to FIG. 1, the transparent material lighting optical component 1 in accordance with the embodiment shown further includes a second reflection surface 5 extending the first reflection surface 3. This second reflection surface 5 is curved in the same manner, i.e. with the same profile, as the first reflection surface 3 and is delimited by the entry surface 2 and the first reflection surface 3. The second reflection surface 5 is coated with a reflective layer, notably aluminized, i.e. a layer containing a significant proportion of aluminum. The first reflection surface 3 and the second reflection surface 5 therefore constitute a continuous surface a portion of which is aluminized. The second reflection surface 5 reflects, by specular reflection, the light rays from the light source 12 passing through the entry surface 2 that do not reach the first reflection surface 3. The reflective layer is applied to the exterior of the transparent material lighting optical component 1. In this embodiment, the light source 12 straddles a plane that separates the first reflection surface 3 from the second reflection surface 5.

FIG. 2 shows the transparent material lighting optical component 1 in accordance with the FIG. 1 embodiment in longitudinal section, as seen from the side. Some light rays issuing from a point, or focus, of the light source 12 are indicated in order to illustrate the optical behavior of the transparent material lighting optical component 1 in accordance with the invention.

The first reflection surface 3 is oriented relative to the entry surface 2 so that light rays from the light source 12 illuminating the entry surface 2 are totally internally reflected by the first reflection surface 3 toward the exit surface 4. These light rays are referenced 13 in FIG. 2. The totally internally light rays pass substantially perpendicularly through the exit surface 4. In the embodiment shown and when the transparent material lighting optical component 1 is located in a vehicle headlight, light rays exiting via the exit surface 4 are therefore directed forward in a collimated manner. Light rays issuing from a point of the light source 12 are therefore rendered parallel to one another by the first reflection surface 3.

Some of the light rays from the light source 12 are reflected toward the exit surface 4 by specular reflection at the transparent material—aluminum interface of the second reflection surface 5. These light rays are referenced 14 in FIG. 2. The light rays 14 from a point of the light source 12 are rendered parallel to one another by the second reflection surface 5.

Other light rays from the light source 12, referenced 18, enter the transparent material lighting optical component 1 via the supplementary entry surface or edge 10. They are refracted by the supplementary entry surface or edge 10 and directed toward the exit surface 4.

In accordance with the embodiment shown in FIGS. 1 and 2, the light source 12 is placed above and in line with the entry surface 2 of the transparent material lighting optical component 1 so that an illuminating surface of the light source 12 is at substantially the same level as the parallel surface 11 of the projecting portion 6. A very large proportion of the light rays emitted by the light source 12 therefore enters the transparent material lighting optical component 1 via the entry surface 2 and the supplementary entry surface or edge 10 and very little of the light emitted by the source remains unused. This arrangement therefore offers a very high efficiency.

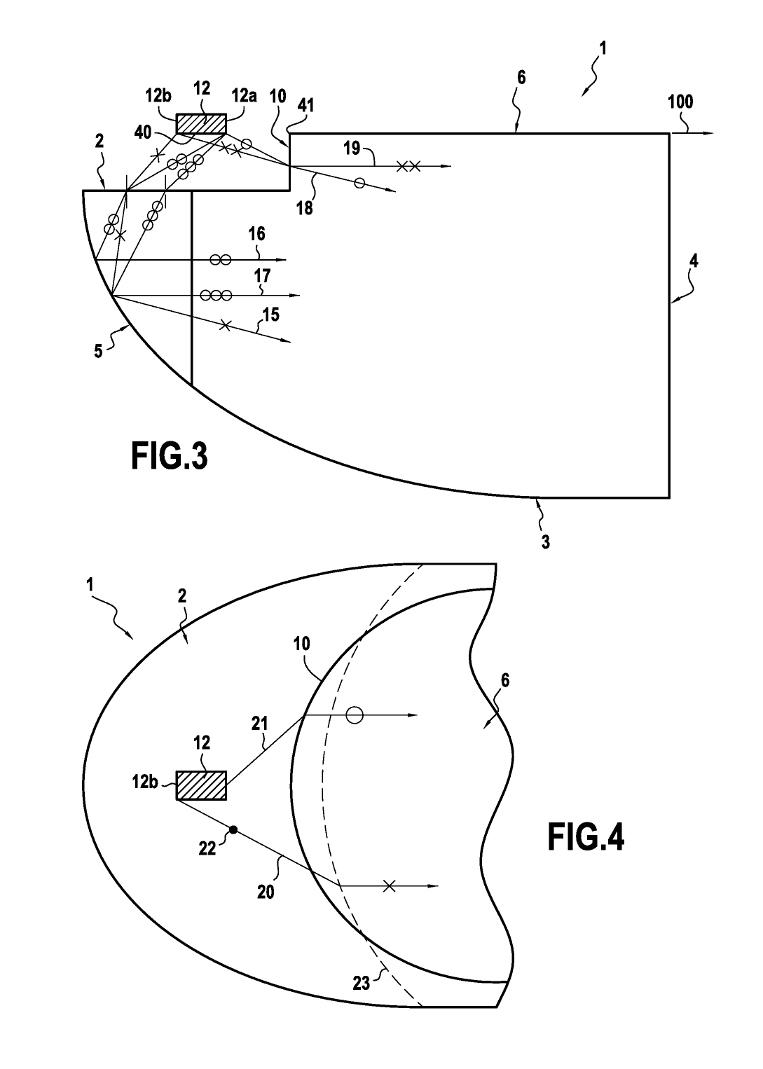

FIG. 3 shows the transparent material lighting optical component 1 in accordance with the FIG. 1 embodiment in longitudinal section, as seen from the side, with only a few examples of light rays emitted by the light source 12. Two foci at the front and rear edges 12a, 12b of the light source 12 are considered.

The rays referenced 15 and 19 and respectively marked by one cross and two crosses start from the focus at the rear edge 12b of the light source 12, for example. The ray 15 marked by one cross enters the transparent material lighting optical component 1 via the entry surface 2. It is refracted by the diopter that constitutes the entry surface 2 and reflected by the second reflection surface 5, i.e. at the aluminum air interface, toward the exit surface 4 that represents the front of the transparent material lighting optical component 1. The ray 19 marked by two crosses enters the transparent material lighting optical component 1 via the supplementary entry surface or edge 10. It is refracted by the diopter that constitutes the supplementary entry surface or edge 10 so as to be directed toward the front of the transparent material lighting optical component 1. Rays incident on the first reflection surface 3 (which are not shown) are reflected toward the exit surface 4 by total internal reflection at the transparent material—air interface.

The rays 16-18 respectively marked by one, two and three circles start from the focus at the front edge 12a of the source 12, for example. The rays 16, 17 respectively marked by two and three circles enter the transparent material lighting optical component 1 via the entry surface 2; they are refracted and reflected in a similar manner to the ray referenced 15 and marked by one cross starting from the rear edge 12b of the source 12. The third ray 18 marked by one circle enters the component via the supplementary entry surface or edge 10; it is refracted in a similar manner to the ray 19 marked by two crosses starting from the rear edge 12b of the light source 12.

In FIG. 3, rays totally internally reflected by the first reflection surface 3 are not shown, for reasons of clarity. However, as is apparent in the FIG. 1 view, their behavior after reflection is similar to that of the rays referenced 15-17 reflected by the second reflection surface 5.

FIG. 4 shows a partial top view of the transparent material lighting optical component 1 and the light source 12. The light source 12 is placed in line with and above the entry surface 2 of the transparent material lighting optical component 1, behind the projecting portion 6, the supplementary entry surface or edge 10 of which is partially shown. Two light rays referenced 20, 21 issuing from a focus at the rear edge 12b of the source 12 are shown. The ray 20 marked by one cross enters the transparent material lighting optical component 1 via the entry surface 2 at point 22 and is totally internally reflected by the first reflection surface 3 that is indicated by a curved dashed line 23. By virtue of the total internal reflection, the ray 20 is directed toward the exit surface (not shown). The ray 21 marked by one circle enters the transparent material lighting optical component 1 via the supplementary entry surface or edge 10. It is refracted and directed toward the exit surface.

FIGS. 3 and 4 show that light rays from the light source 12 are all directed forwardly and slightly toward the bottom of the transparent material lighting optical component 1. The distribution of light generated by the transparent material lighting optical component 1 in accordance with the invention therefore features the horizontal cut-off as prescribed by the law and referred to above. In accordance with the invention, the cut-off of the low beam type beam is generated by the edge 10, where applicable additionally by the projecting portion 6. The transparent material lighting optical component 1 in accordance with the invention is then particularly suitable for providing the low beam function in a motor vehicle front headlight.

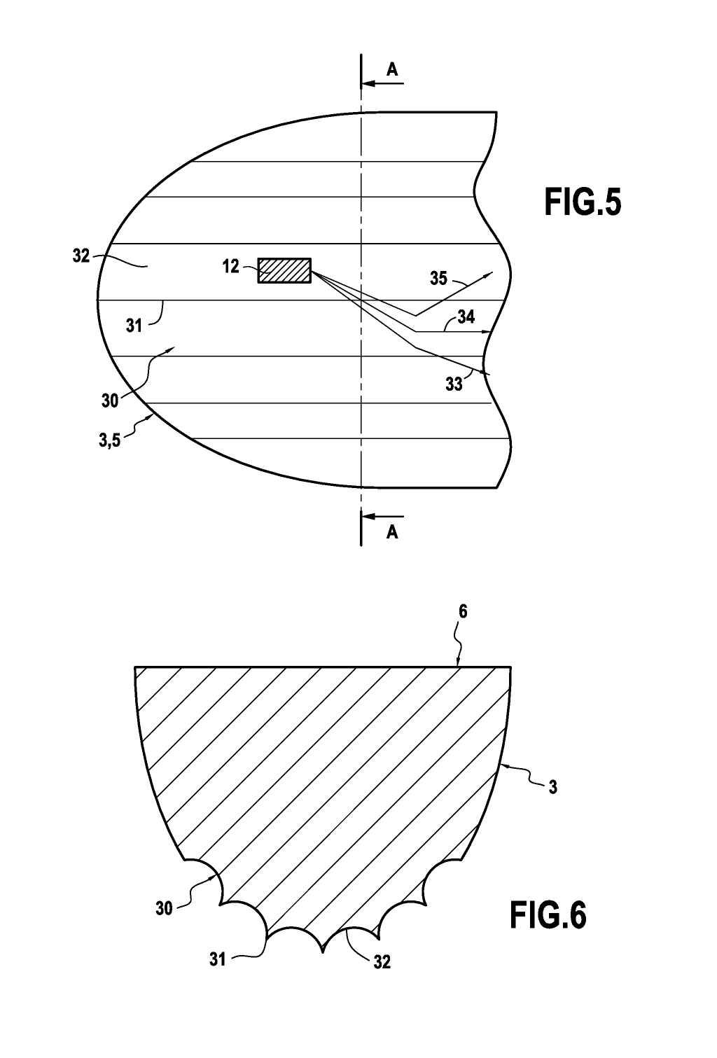

FIGS. 5 and 6 are partial views of a transparent material lighting optical component in accordance with another embodiment of the invention. FIG. 5 is a partial top view of the transparent material lighting optical component 1 and the light source 12. The entry surface has been represented as entirely transparent for reasons of clarity. The reflection surfaces 3, 5 are seen from the top of the transparent material lighting optical component 1, i.e. as if from the position of the light source 12, as well as the light source 12 placed above the transparent material lighting optical component 1. FIG. 6 is a section of the transparent material lighting optical component 1 taken along the line A-A indicated in FIG. 5. In accordance with this embodiment, the first reflection surface 3 and the second reflection surface 5 are provided with integral elements in the form of striations 30. The striations 30 are curved longitudinal surfaces 32, each surface 32 having a convex section as seen from the light source 12. The convex sections of the curved surfaces 32 can be seen in FIG. 6. The curved surfaces 32 are separated from one another by edges 31.

When, as shown in FIG. 5, light rays 33-35 from the light source 12 reach each of the curved surfaces or striations 30, the rays 33-35 are reflected in different directions according to their angle of incidence. The reflection angles shown in FIG. 6 for the rays referenced 33, 35 have been exaggerated to render them more visible. The technical effect of the striations 30 is to generate a well defined distribution of light.

In accordance with other embodiments, the exit face of the transparent material lighting component 1 in accordance with the invention may also include integral elements. The integral elements may be prisms or striations like those described above, for example. The beam emitted by the transparent material lighting component 1 can therefore be fashioned in accordance with a precise specification as a function of specific lighting requirements.

In the above description (FIG. 3), the light source 12 is placed relative to the transparent material lighting optical component 1 so that a plane passing through an illuminating surface 40 of the light source 12 passes at least through an external line of intersection 41 of the edge 10. In a complementary manner, note that the plane passing through the illuminating surface 40 coincides with a plane in which the parallel surface 11 of the projecting portion 6 is inscribed.

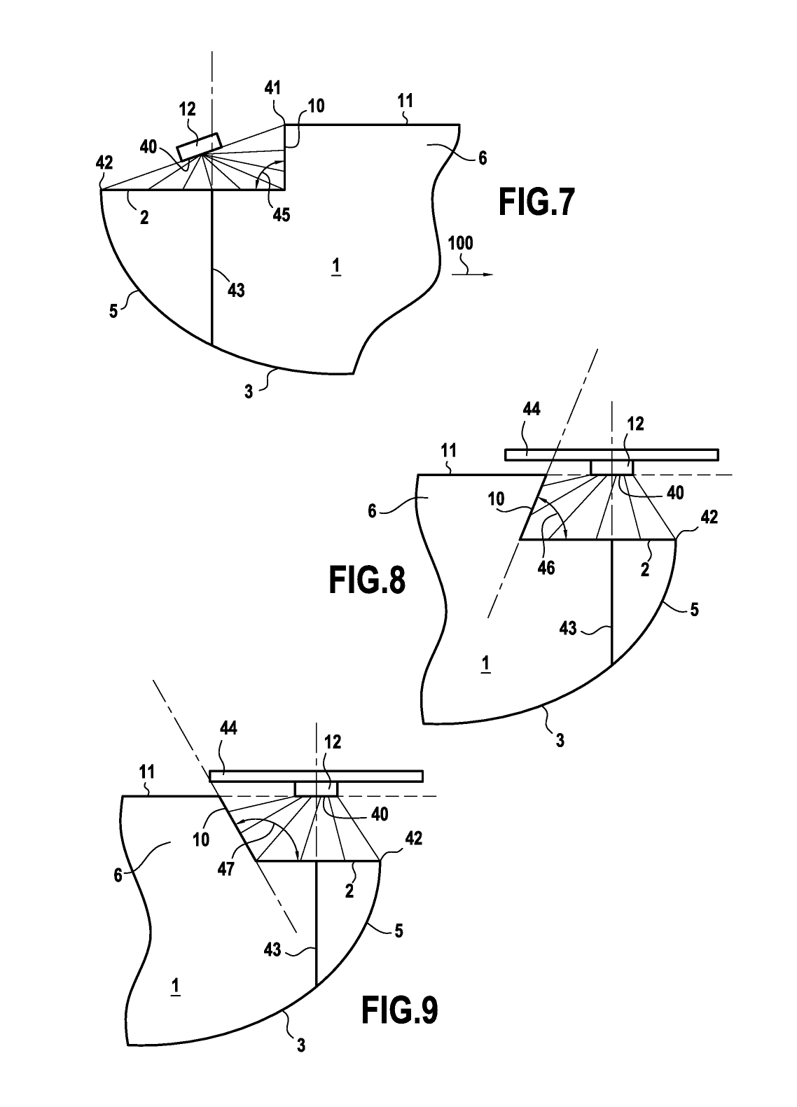

FIG. 7 shows another example of the position of the light source 12 in line with the entry surface 2. The light source 12 is placed relative to the transparent material lighting optical component 1 so that the plane passing through the illuminating surface 40 of the light source 12 passes through the external line of intersection 41 of the edge 10. In this embodiment, the plane of the illuminating surface 40 does not coincide with that of the parallel surface 11.

The light source 12 is delimited by this illuminating surface 40 through which the light rays pass in an angular sector equal to 180°. The light source 12 is turned about an axis passing through its center and transverse to the direction 100 of emission of the light beam leaving the transparent material lighting optical component 1. The angle formed between the illuminating surface 40 and the entry surface 2 may be between 0°, when the illuminating surface 40 is parallel with the entry surface 2, and 45°. In such a situation, the illuminating surface 40 is below the parallel surface 11 of the projecting portion 6 and above the entry surface 2. The angular orientation of the light source 12 makes it possible to couple the 180° radiating angular sector with the entry surface 2 and the edge 10. Lighting efficiency is improved by recovering a great proportion of the light rays emitted by the light source 12. It is therefore clear that the plane passing through the illuminating surface 40 of the light source 12 is inclined relative to the plane in which the entry 2 surface is inscribed.

In the FIG. 7 embodiment, the plane in which the illuminating surface 40 is inscribed also passes through a terminal line of intersection 42. This line of intersection 42 is terminal in the sense that is situated at the rear end of the transparent material lighting optical component 1, opposite the exit surface 4. This terminal line of intersection 42 is formed at the level of the second reflection surface 5 and forms the angle between this second reflection surface 5 and the entry surface 2.

In FIGS. 7 to 9 a line 43 symbolizes the boundary between the first reflection surface 3 and the second reflection surface 5. This line 43 passes through the light source 12.

FIGS. 8 and 9 show the illuminating surface 40 of the light source 12 aligned in the plane of the parallel surface 11. The light source 12 is mechanically retained on an electronic circuit or directly on a heatsink 44, represented diagrammatically.

In FIG. 7, an angle 45 formed between the plane in which the entry surface 2 is inscribed and a tangential straight line segment passing through the edge 10 is equal to 90° or substantially 90°.

In FIG. 8, an angle 46 formed between the plane in which the entry surface 2 is inscribed and a tangential straight line segment passing through the edge 10 is acute.

In FIG. 9, an angle 47 formed between the plane in which the entry surface 2 is inscribed and a tangential straight line segment passing through the edge 10 is obtuse.

Such features make it possible to control how light rays entering via the edge 10 propagate in the transparent material lighting optical component 1.

The device in accordance with the invention may also include a heatsink (not shown) for cooling the light source 12. In this case, the heatsink is advantageously placed above the light source 12. The device, intended to be incorporated into a vehicle headlight, therefore remains compact in the lengthwise direction. The thermal dissipation of the heat produced by the light source 12 is also improved.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A vehicle lighting device including a transparent material lighting optical component, sais transparent material lighting optical component, delimited by:
at least one entry surface;
at least one first reflection surface arranged substantially facing said at least one entry surface; and
exit surface;
wherein said at least one first reflection surface is oriented relative to said at least one entry surface so that light rays from a light source passing through said at least one entry surface are directed by said at least one first reflection surface toward said exit surface, wherein said transparent material lighting optical component comprises said light source arranged relative to said at least one entry surface of said transparent material lighting optical component so that light rays from said light source passing through said at least one entry surface are reflected by said at least one first reflection surface toward said exit surface.

2. The vehicle lighting device according to claim 1, wherein said light source is placed above and in line with said at least one entry surface.

3. The vehicle lighting device according to claim 1, wherein said transparent material lighting optical component is delimited by at least one edge that extends from said at least one entry surface toward an exterior of said transparent material lighting optical component.

4. The vehicle lighting device according to claim 3, where a plane in which an illuminating surface of said light source is inscribed passes through a plane intersected by an external line of intersection of said at least one edge.

5. The vehicle lighting device according to claim 1, wherein a plane passing through an illuminating surface of said light source is inclined relative to a plane in which said at least one entry surface is inscribed.

6. The vehicle lighting device according to claim 5, wherein said plane passing through said illuminating surface of said light source intersects a terminal line intersection of said transparent material lighting optical component and an external line of intersection of said at least one edge.

7. The vehicle lighting device according to claim 3, wherein said at least one edge constitutes a supplementary entry surface so that light rays from said light source that so not reach said at least one entry surface and pass through said supplementary entry surface are directed toward said exit surface.

8. The vehicle lighting device according to claim 3, wherein said at least one edge delimits a portion of said at least one entry surface projecting toward an exterior of said transparent material lighting optical component.

9. The vehicle lighting device according to claim 1, wherein said at least one entry surface is plane and said at least one first reflection surface has a concave shape as seen from said light source.

10. The vehicle lighting device according to claim 1, wherein said exit surface is plane.

11. The vehicle lighting device according to claim 1, wherein said at least one entry surface and said exit surface are continuous.

12. The vehicle lighting device according to claim 1, wherein said at least one entry surface and said exit surface are each inscribed in a plane perpendicular one relative to the other.

13. The vehicle lighting device according to claim 7, wherein said supplementary entry surface is convex as seen from said light source.

14. The vehicle lighting device according to claim 7, wherein said supplementary entry surface is cylinder portion the generatrices of which are parallel to said exit surface.

15. The vehicle lighting device according to claim 1, further including a second reflection surface extending said at least one first reflection surface, said second reflection surface being coated with a reflective layer so that some of the light rays from said light source passing through said at least one entry surface are reflected toward said exit surface.

16. The vehicle lighting device according to claim 1, wherein a transparent material is chosen from PMMA, PMI and polycarbonate.

17. A vehicle headlight including at least one vehicle lighting device according to claim 1.

18. A vehicle lighting device including a transparent material lighting optical component, said transparent material lighting optical component, delimited by:
at least one entry surface;
at least one first reflection surface arranged substantially facing said at least one entry surface;
an exit surface; and
at least one edge that extends from said at least one entry surface;
wherein said at least one first reflection surface is oriented relative to said at least one entry surface so that light rays from a light source passing through said at least one entry surface are directed by said at least one first reflection surface toward said exit surface, wherein said transparent material lighting optical component comprises said light source arranged relative to said at least one entry surface of said transparent material lighting optical component so that said light rays from said light source passing through said at least one entry surface and said at least one edge.

19. The vehicle lighting device according to claim 18, wherein said light source is placed above and in line with said at least one entry surface.

20. The vehicle lighting device according to claim 18, wherein said at least one edge extends from said at least one entry surface toward an exterior of said transparent material lighting optical component.

21. The vehicle lighting device according to claim 18, wherein said at least one edge constitutes a supplementary entry surface so that light rays from said light source that do not reach said at least one entry surface and pass through said supplementary entry surface are directed toward said exit surface.
